(19) United States
(12) Patent Application Publication
(10) Pub. No.: US 2022/0393181 A1
(43) Pub. Date: Dec. 8, 2022

(54) LEAD-ACID BATTERY HAVING FIBER ELECTRODE WITH LEAD-CALCIUM STRAP

(71) Applicant: CPS Technology Holdings LLC, New York, NY (US)

(72) Inventors: Jeffrey L. Troxel, Menomonee Falls, WI (US); Paul D. Korinek, West Bend, WI (US)

(21) Appl. No.: 17/761,939

(22) PCT Filed: Sep. 18, 2020
(86) PCT No.: PCT/US2020/051369

§ 371 Date: Mar. 18, 2022

Related U.S. Application Data
(60) Provisional application No. 62/903,561, filed on Sep. 20, 2019.

(51) Int. Cl. H01M 4/68; H01M 10/06; H01M 50/431

(52) U.S. Cl. CPC H01M 4/68; H01M 10/06; H01M 50/431

(57) ABSTRACT

A lead-acid battery is disclosed. The battery comprises a container with a cover having one or more compartments. One or more cell elements are provided in the one or more compartments. The cell elements comprise a positive electrode and a negative electrode. The positive electrode has a positive current collector and a positive electrochemically active material in contact therewith. The negative electrode has a negative current collector and a negative electrochemically active material in contact therewith. At least one of the positive electrode or the negative electrode comprises a cured carbon or carbonized fiber mat current collector impregnated with the respective electrochemically active material. The cured carbon or carbonized fiber mat current collector comprises a frame member composed of a lead-calcium alloy. Electrolyte is provided within the container. One or more terminal posts extend from the container or the cover and are electrically coupled to the cell elements.

### CROSS-REFERENCE TO RELATED APPLICATIONS

This application claims priority from U.S. Provisional Patent Application, Ser. No. 62/903,561 filed Sep. 20, 2019, entitled “ABSORBENT GLASS MAT BATTERY WITH LEAD-CALCIUM STRAP”, the entire contents of which is hereby incorporated by reference herein in its entirety.

### BACKGROUND

The present disclosure relates to the field of batteries. The present disclosure more specifically relates to the field of lead-acid batteries.

Lead-acid batteries are known. Lead-acid batteries are made up of plates of lead and separate plates of lead dioxide, which are submerged into an electrolyte or acid solution. The lead, lead dioxide and electrolyte provide a chemical means of storing electrical energy which can perform useful work when the terminals of a battery are connected to an external circuit. The plates of lead, lead dioxide and electrolyte, together with a battery separator, are contained within a housing of a polypropylene material.

Start-stop vehicles can place various demands on a lead-acid battery. Vehicles also are increasing in the electrical load of components, for which the electrical load must be supported through a stop event. Vehicle manufacturers are seeking a cost effective, reliable energy storage solution that ensures a seamless customer experience. Therefore, there is a need for consistent reliable performance from a lead-acid battery. There is also a need for a robust battery which can support additional prolonged/intermittent loads and support optimal duration and frequency of stop events. To this end, a need exists for a lead-acid battery which provides sustainable and fast rechargeability (e.g., optimized charge acceptance) and consistent cycling performance. Accordingly, a need exists for a lead-acid battery with improved performance over existing devices.

### SUMMARY

A lead-acid battery is disclosed. The battery comprises a container with a cover having one or more compartments. One or more cell elements are provided in the one or more compartments. The cell elements comprise a positive electrode and a negative electrode. The positive electrode has a positive current collector and a positive electrochemically active material in contact therewith. The negative electrode has a negative current collector and a negative electrochemically active material in contact therewith. At least one of the positive electrode or the negative electrode comprises a cured carbon or carbonized fiber mat current collector impregnated with the respective electrochemically active material. The cured carbon or carbonized fiber mat current collector comprises a frame member composed of a lead-calcium alloy. Electrolyte is provided within the container. One or more terminal posts extend from the container or the cover and are electrically coupled to the cell elements.

An electrode for a lead-acid battery is also disclosed. The electrode comprises a cured carbon or carbonized fiber mat current collector impregnated with an electrochemically active material and a frame member composed of a lead-calcium alloy.

A current collector is also disclosed. The current collector comprises a cured carbon or carbonized fiber mat. The cured carbon or carbonized fiber mat current collector comprises a frame member composed of a lead-calcium alloy.

These and other features and advantages of devices, systems, and methods according to this invention are described in, or are apparent from, the following detailed descriptions of various examples of embodiments.

### BRIEF DESCRIPTION OF DRAWINGS

Various examples of embodiments of the systems, devices, and methods according to this invention will be described in detail, with reference to the following figures, wherein:

FIG. 1 is a perspective view of a vehicle for use with a lead-acid battery according to one or more examples of embodiments described herein.

FIG. 2 is a perspective view of a lead-acid according to one or more examples of embodiments described herein.

FIG. 3 is a perspective view of the lead-acid battery shown in FIG. 2, with the cover removed.

FIG. 4 is an exploded perspective view of a lead-acid battery according to one or more examples of embodiments described herein.

FIG. 5 is a partial, side elevation view of a cell element according to one or more examples of embodiments for use with the lead-acid battery shown in FIGS. 2-4.

FIG. 6 is an elevation view of an example battery grid or substrate or current collector for use with the lead-acid battery shown in FIGS. 2-4.

FIG. 7 is an additional elevation view of an example battery grid or substrate or current collector for use with the lead-acid battery shown in FIGS. 2-4.

FIG. 8 is an elevation view of an alternative example battery grid or substrate or current collector for use with the lead-acid battery shown in FIGS. 2-4, showing section details of the illustrated grid.

FIG. 9 is a current collector or substrate for use with the lead-acid battery described herein, showing example fibers in exaggerated dimensions for purposes of illustration.

FIG. 10 is another view of a current collector or substrate for use with the lead-acid battery of FIG. 9.

FIG. 11 is a sectional view of the current collector or substrate of FIG. 10, taken from section 11 of FIG. 10.

FIG. 12 is a close up cut away image of an example carbon fiber fabric which may be used with the current collector or substrate of FIGS. 9-11.

FIG. 13 is a close up cut away image of an alternative example carbon fiber fabric which may be used with the current collector or substrate of FIGS. 9-11.

FIG. 14 is a close up cut away image of an alternative example carbon fiber fabric which may be used with the current collector or substrate of FIGS. 9-11.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

Referring to the Figures, a battery 100 is disclosed, and in particular a rechargeable battery, such as, for example, a lead-acid battery. Various embodiments of lead-acid storage batteries may be either sealed (e.g., maintenance-free) or unsealed (e.g., wet). While specific examples are described and illustrated, the battery 100 may be any secondary battery suitable for the purposes provided.

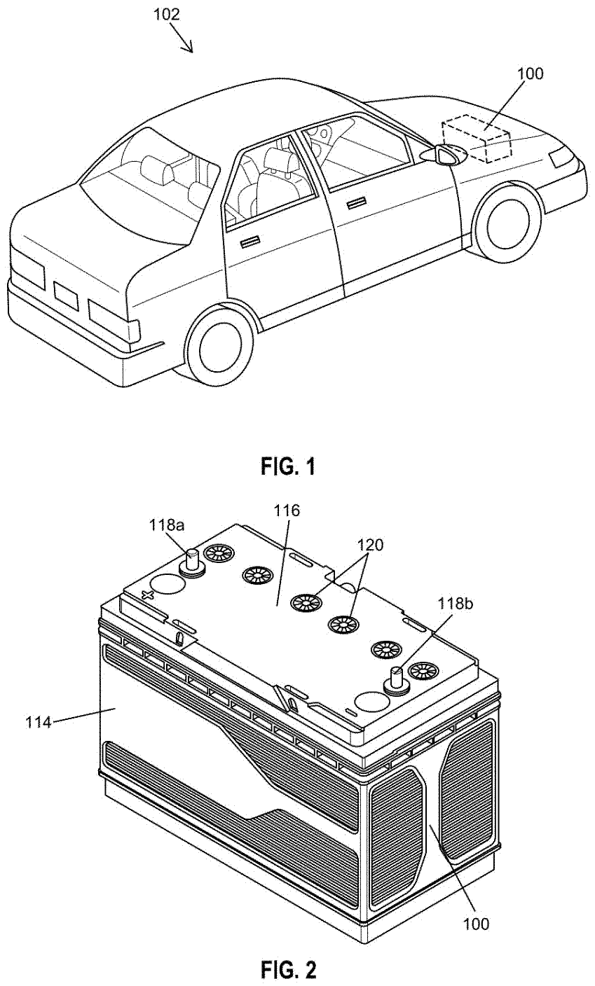

One example of a battery 100 is provided and shown in a vehicle 102 in FIG. 1. While a vehicle battery is shown and described, the disclosure and system described herein are not limited thereto. The battery 100 may be any type of lead-acid battery, including for example, industrial or back-up batteries, as well as other types of lead-acid batteries. Referring to FIGS. 2-4, the battery 100 is a lead-acid battery. The lead-acid battery 100 is composed of a housing 114 or container which includes a cover 116. Cover 116 is provided for the container or housing 114 and may be sealed to the container 114. In various embodiments, the container 114 and/or cover 116 includes battery terminals 118a, b. The battery cover 116 may also include one or more filler hole caps and/or vent assemblies 120 (see FIG. 2). The housing 114 and cover 116 may be primarily composed of a polymer material. In one or more examples of embodiments, the polymer material may be a recycled polymer material. An electrolyte, which typically comprises sulfuric acid, may be included in the battery 100 within the housing 114.

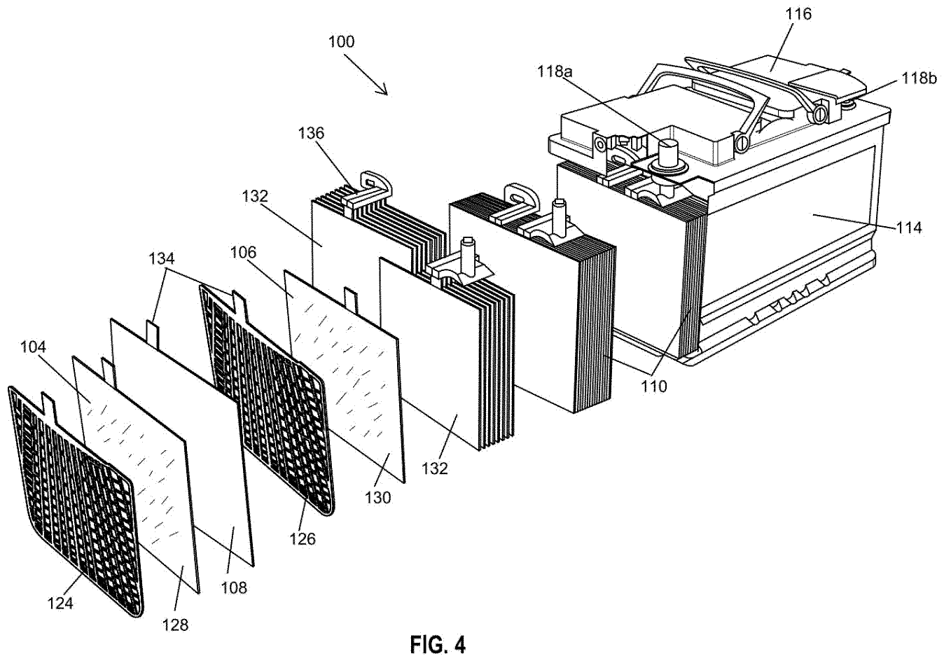

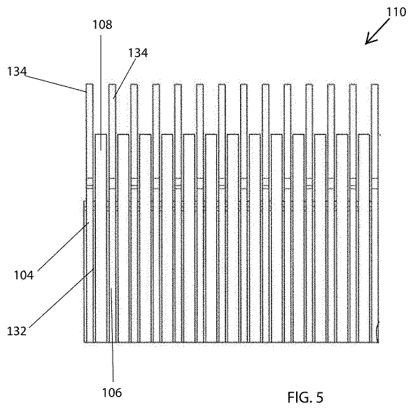

Within the container 114 are positive and negative electrodes or plates 104, 106. Referring to FIG. 4, the electrodes 104, 106 include electrically conductive positive or negative current collectors or substrates or grids 124, 126 or current collector 1001 as discussed in further detail herein. To this end, a “grid” may include any type of mechanical or physical support for the active material. Positive paste or electrochemically active material 128 is provided in contact with and/or on the positive grid 124 and negative paste or electrochemically active material 130 is provided on the negative grid 126. Positioned between the positive and negative electrodes or plates 104, 106 is a separator 108. In a retained electrolyte-type battery 100, the separator 108 may be a porous and absorbent glass mat (AGM). In one or more examples of embodiments, the lead-acid battery herein may be an AGM lead-acid battery.

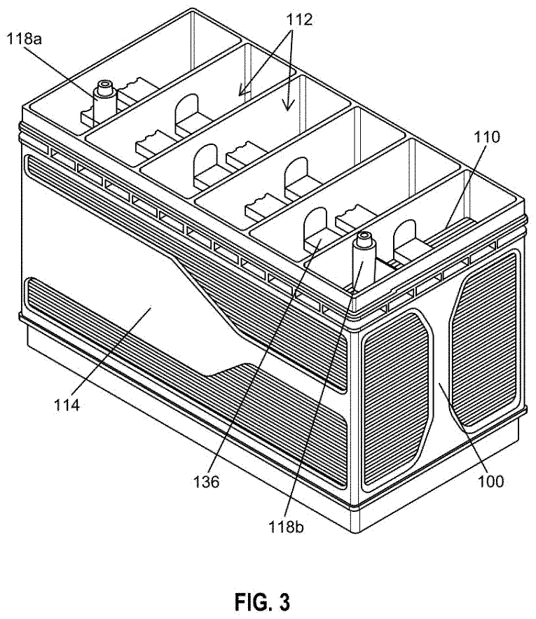

A plurality of positive electrodes or plates 104 and a plurality of negative electrodes or plates 106 (with separators 108) generally make up at least a portion of the electrochemical cell 110 (see FIGS. 3-4). Referring to FIGS. 3-4, a plurality of plate or electrode sets or books or cell elements 110 may be electrically connected, e.g., electrically coupled in series or other configuration, according to the capacity of the lead-acid storage battery 100. The plurality of positive electrodes or plates 104 and negative electrodes or plates 106 may be provided in stacks or sets or cell elements 110 for producing a battery having a predetermined voltage, as one example a 12-volt battery in a vehicle 102. The number of cell elements 110 or groups or sets may be varied. It will also be obvious to those skilled in the art after reading this specification that the size and number of electrodes 104 and/or 106 in any particular group (including the size and number of the individual current collectors), and the number of groups used to construct the battery 100 may vary depending upon the desired end use. In an AGM lead-acid battery 100 which includes several cell elements 110 provided in one or more separate compartments 112 of a container or housing 114, the element stack 110 may be compressed during insertion reducing the thickness of the separator 108.

Each current collector has a lug 134 (see FIG. 4). In FIGS. 3-4, one or more cast-on straps or intercell connectors 136 are provided which electrically couple the lugs 134 of like polarity in an electrode or plate set or cell element 110 and to connect other respective sets or cell elements 110 in the battery 100. The connection of the elements may be a single element, parallel connection (capacity doubled, voltage the same) or series connection (e.g., voltages are additive, i.e., 4V, 6V, etc., with the same capacity). One or more positive terminal posts 118a and one or more negative terminal posts 118b (FIGS. 2-4) may also be provided, electrically coupled to the cell elements 110. Such terminal posts 118a, b typically include portions which may extend through the cover and/or container wall, depending upon the battery design. It will be recognized that a variety of terminal arrangements are possible, including top, side, front or corner configurations known in the art. The intercell connectors 136 and/or terminals 118a, b may be composed of lead or lead alloy. In one or more examples the lead may be a recycled lead.

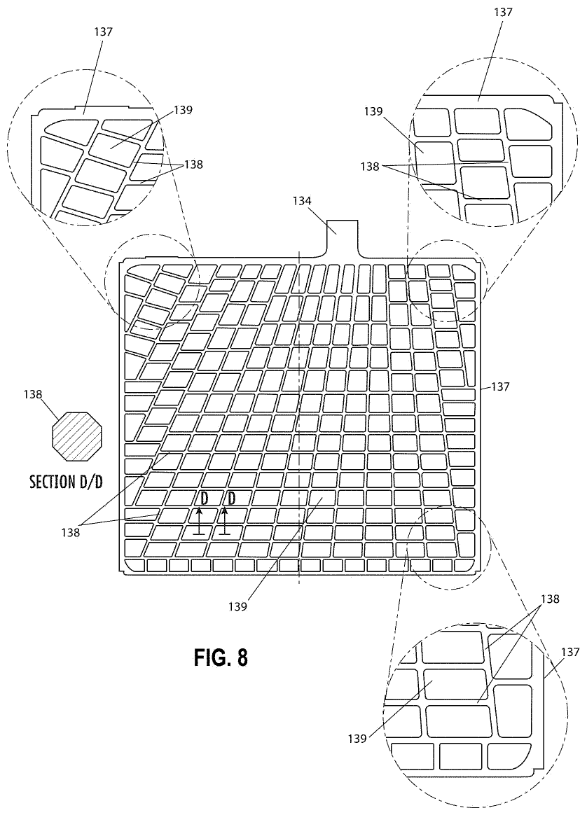

As described and referring to FIGS. 4-8, the electrodes 104, 106 include electrically conductive positive or negative current collectors or substrates or grids 124, 126. In one or more examples of embodiments, the positive grid or current collector or substrate 124 and/or the negative grid or current collector or substrate 126 may be composed of lead or lead alloy, which in some examples of embodiments may be or include a recycled lead.

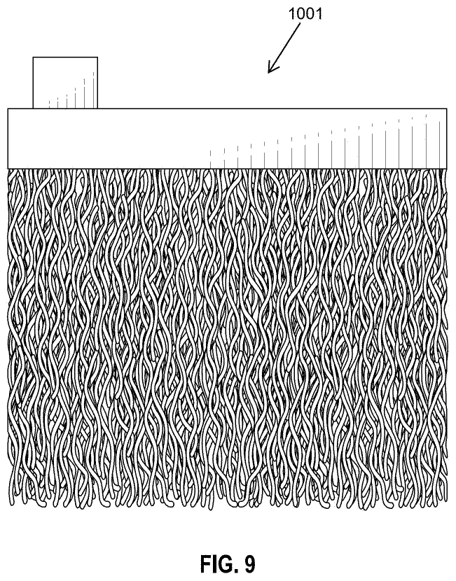

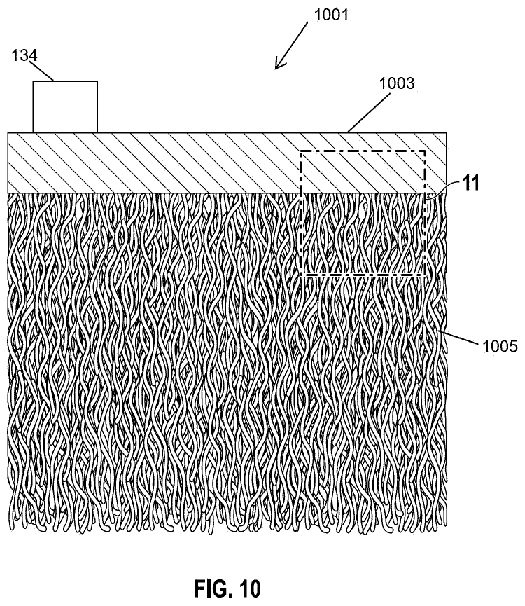

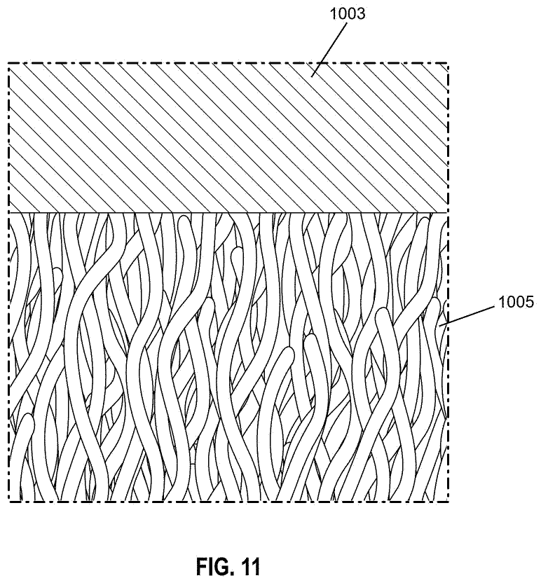

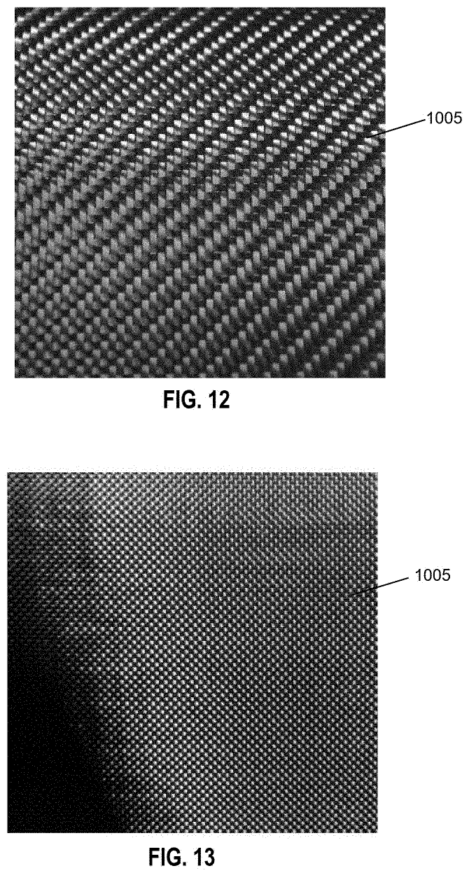

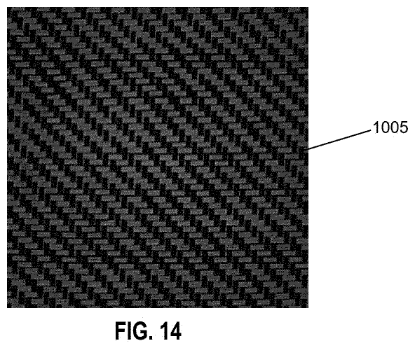

However, a “grid” as used herein may include any type of mechanical support for the active material. For instance, according to one or more preferred examples of embodiments described herein at least one of the positive grid or the negative grid may comprise a fibrous material, such as a fiber mat 1005. According to one or more preferred examples of embodiments, the current collector is a conductive fibrous material forming a conductive fibrous matrix 1005. More specifically, the conductive fibrous material or conductive fibrous matrix 1005 may be a mat made of carbon or carbonized fibers. The fibers may be textile fiber material. For example, in various embodiments, the current collector may be understood to be formed from a felt-like fabric material. Accordingly, one of skill in the art will appreciate that a carbonized fiber mat 1005 may have an appearance similar to the fiber mats shown in FIGS. 12-14, and the fibers may be woven or non-woven (see FIGS. 9-12). In FIGS. 9-10, the carbonized fibers of the mat or matrix 1005 are shown in exaggerated dimensions to illustrate the voids which may be present within the fiber fabric (discussed in further detail hereinbelow). The conductive fibrous matrix provides a void volume formed by voids within the fiber matrix, between the fibers. These voids may be filled by active material or paste, or electrolyte. The voids and fibers also provide enhanced surface area to the current collector. In one or more examples of embodiments, the conductive fiber mat 1005 may have undergone a curing step to convert the fiber mat into a stiff current collector or substrate. The conductive fibrous material may also be present in multiple layers or a single layer.

The current collector or substrate 1001 may have a strap or frame member 1003 coupled to the mat portion 1005. The strap 1003 is bonded to the top border of the fiber mat 1005. The lead alloy strap may be connected to the fiber mat or substrate by penetration into and/or between the fibers of the fibrous material. The strap 1003 extends along the edge of the current collector 1005, and preferably along the entire length of the edge of the current collector. This strap may be understood to be electrically in communication with the mat portion 1005. Accordingly, in reference to FIGS. 9-11, the current collector or substrate 1001 comprises a mat of conductive fibers 1005, e.g., carbonized fibers, affixed to a strap 1003 having a lug 134. In this regard, the lead alloy strap 1003 has a lug 138 on a top portion thereof for electrical connection within the battery 100.

The strap having a lug may be formed of metal such as lead. In various embodiments, the strap or frame member 1003 may be comprised of a metal or lead alloy. Specifically, in various embodiments, the alloy may be a calcium alloy or calcium tin alloy. In various embodiments, the strap or frame member 1003 may comprise a lead-calcium alloy. In other examples of embodiments, the frame member 1003 may be a lead-calcium-tin alloy. While a lead-calcium alloy and lead-tin-calcium alloy are described, various alloys should be understood as within the scope of this disclosure. In some examples of embodiments, the lead alloy may include one or more of aluminum, tin, silver, antimony, and/or calcium. Likewise, the alloy may also include one or more impurities.

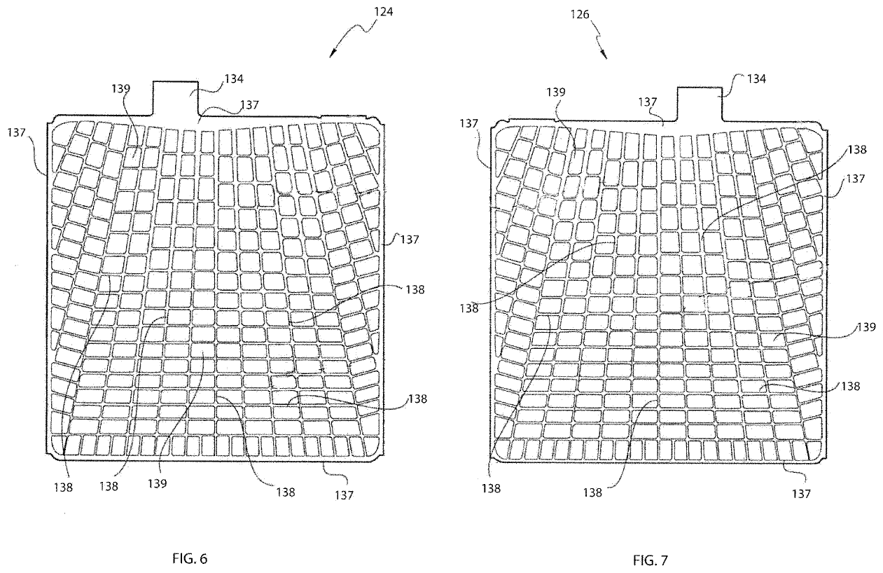

Referring to FIGS. 6-14, the substrates or grids or current collectors 124, 126, 1001 may be composed the same or similar material. It is contemplated, however, that material composition may also vary between the positive and the negative electrodes 104, 106 or current collectors. To this end, one or both of the current collectors (positive, negative, or both) may be stamped or punched fully framed grids 124, 126 having a frame 137 and a radial arrangement of grid wires 138 forming a pattern of open spaces 139 (various examples of grids 124, 126 suitable for use with the inventions described herein are shown and described in U.S. Pat. Nos. 5,582,936; 5,989,749; 6,203,948; 6,274,274; 6,953,641, 8,709,664, and 9,130,232 which are hereby incorporated by reference herein). In various embodiments, one or both current collectors (positive, negative, or both) may comprise a conductive fiber mat (e.g., current collector 1001). In some embodiments, only the positive electrode 104 may comprise a conductive fiber mat current collector 1001. In other examples of embodiments, only the negative electrode 106 may comprise a conductive fiber mat current collector 1001. Accordingly, in various examples of embodiments, the grid or substrate of the positive electrode 104 or negative electrode 106 may be a punched grid, a continuously cast (concast) grid, an expanded metal grid, a carbon or carbonized felt or fiber substrate, ceramic, and so forth. In some examples of embodiments, the grid or current collector may also include surface roughening or may be subjected to one or more different surface treatments (e.g., solvent, surfactant and/or steam cleaning), such as may be used to improve paste adhesion among other benefits. In one example of embodiments, the positive and negative current collectors may also be formed of different thickness. However, it is contemplated that the current collectors may be of the same thickness. The thickness of each current collector may be varied based upon desired manufacturing and performance parameters. For instance, thickness may be determined based upon manufacturing requirements, such as for instance, minimum requirements for paste adhesion, improved cycle performance, endurance, or other suitable parameters. While specific examples are provided for purposes of illustration, variations thereon may be made to provide grid dimensions suitable for the particular application. Likewise, while specific examples of current collector, grid, and substrate arrangements and grid or substrate types are described for purposes of example, one of skill in the art will appreciate that any grid structure or arrangement suitable for the purposes of the battery 100 may be substituted in place of the described grids/substrates 124, 126, 1001.

As described in various embodiments herein, the positive and negative electrodes or plates 104, 106 are paste-type electrodes (FIG. 4). Thus, each plate 104, 106 comprises a current collector or grid 124, 126, 1001 pasted with electrochemically active material 128, 130. More specifically, the paste-type electrode includes a current collector or grid which acts as a substrate and an electrochemically active material or paste is provided in contact with and/or on the substrate. The current collectors or grids 124, 126, 1001, including a positive grid and a negative grid, provide an electrical contact between the positive and negative electrochemically active materials or paste 128, 130 which may serve to conduct current. More specifically, positive paste 128 is provided in contact with and/or on the positive grid 124 and negative paste 130 is provided in contact with and/or on the negative grid 126. That is, the positive plate 104 includes a positive grid 124 having or supporting a positive electrochemically active material or paste 128 thereon, and in some examples of embodiments may include a pasting paper or a woven or non-woven sheet material comprised of fibers (e.g., a “scrim”) 132; and the negative plate 106 includes a negative grid 126 having or supporting a negative electrochemically active material or paste 130 thereon, and in some examples of embodiments may include a pasting paper or scrim 132. The scrim, in one or more examples of embodiments may be composed of or include glass fibers. In other examples, the scrim may include other fiber materials, such as but not limited to polymer.

As described and shown in FIG. 10, the current collector 1001 may comprise a fiber mat portion 1005 which may comprise, for example, a plurality of carbonized fibers. In this example, the current collector may be provided with a paste and cured, forming an electrode. That is, the current collector 1001 may be understood to be impregnated with a paste and have undergone a curing step (either before or after impregnation with a paste) to produce a stiff grid.

The electrochemically active material or paste (positive and negative) may be formed of compositions including lead or lead oxide. In one or more examples, the lead may be a recycled lead. As is known, the paste or electrochemically active material (positive or negative) is oftentimes a mixture of lead and lead oxide or lead dioxide particles and dilute sulfuric acid, and may include other additives, such as carbon, barium sulfate, and/or expander such as lignosulfonate. Additives may be provided in varying amounts and combinations to the paste (positive and/or negative) suitable for the intended purposes of the battery. Alternative negative mass/paste recipes may also be provided which accomplish the objectives described herein. It is also contemplated that other materials or compositions may be present in the paste mix, such as for example, water, fibers (e.g., polymer or glass), sulfuric acid, and so forth. Different materials may be used in connection with the lead-containing paste composition, with the present invention not being restricted to any particular materials or mixtures (added fibers, or other constituents). These materials may be employed alone or in combination as determined by numerous factors, including for example, the intended use of the battery 100 and the other materials employed in the battery.

In more detail, the positive electrode or plate 104 may contain a substrate or grid 124 or 1001 with lead dioxide active material or paste 128 thereon or in contact therewith. The negative electrode or plate 106 may be composed of a substrate or grid 126 or 1001 with a spongy lead active material or paste 130 thereon or in contact therewith. The negative paste 130 may, in a preferred embodiment, be substantially similar to the positive paste 128 but may also vary. In addition, the negative active material or paste 130 may also contain fiber and/or “expander” additives which may help maintain the active material structure and improve performance characteristics, among other things.

As indicated, positioned between the positive and negative electrodes or plates 104, 106 is a separator 108 (see FIGS. 4-5). An AGM lead-acid battery has positive and negative electrodes or plates 104, 106 which are separated by an absorbent glass mat 108 that absorbs and holds the battery's acid or electrolyte and prevents it from flowing freely inside the battery 100 (see FIG. 5). To this end, the separator 108 may be a porous and absorbent glass mat (AGM). The working electrolyte saturation is at some value below 100% saturation to allow recombinant reactions of hydrogen and oxygen. In some examples, the absorbent glass mat 108 may also be used with an additional separator (not shown); various common commercially available separators are known in the art. The separator may be a “U-shape” wrapping the plate or electrode, but the separator or AGM can be a single sheet or, for example, can be a single length concertina with plates separated by 2 layers. Accordingly, in various embodiments, the electrode including the current collector, e.g., current collector 1001, may further be wrapped in or interleaved with a separator. A single or double layer of separator 108 may be employed. For example, a separator may be provided on the positive plate 104 and an AGM 108 may also be employed with the positive/negative plates 104, 106.

An electrolyte, which is typically sulfuric acid, may be included in the battery 100. In various examples, the electrolyte may include one or more metal ions. To this end, the sulfuric acid electrolyte may be a sulfuric acid solution including one or more metal sulfates.

Accordingly, as described above a lead-acid battery is provided. The battery comprises a container with a cover having one or more compartments. One or more cell elements are provided in the one or more compartments. The cell elements comprise a positive electrode and a negative electrode. The positive electrode has a positive current collector and a positive electrochemically active material in contact therewith. The negative electrode has a negative current collector and a negative electrochemically active material in contact therewith. At least one of the positive electrode or the negative electrode comprises a cured carbon or carbonized fiber mat current collector impregnated with the respective electrochemically active material. The cured carbon or carbonized fiber mat current collector comprises a frame member composed of a lead-calcium alloy. The lead-calcium alloy may be a lead-calcium-tin alloy. Electrolyte is provided within the container. One or more terminal posts extend from the container or the cover and are electrically coupled to the cell elements.

An electrode for a lead-acid battery is also provided. The electrode comprises a cured carbon or carbonized fiber mat current collector impregnated with an electrochemically active material and a frame member composed of a lead-calcium alloy. The lead-calcium alloy may be a lead-calcium-tin alloy.

A current collector is also provided. The current collector comprises a cured carbon or carbonized fiber mat. The cured carbon or carbonized fiber mat current collector comprises a frame member composed of a lead-calcium alloy. The lead-calcium alloy may be a lead-calcium-tin alloy.

A lead-acid battery and an electrode formed with a current collector comprising a conductive fiber mat with a lead-calcium alloy or lead-calcium-tin alloy strap has various advantages. In particular, in addition to the unique properties attributable to the use of a carbon fiber matrix or mat, the alloy used for the strap connected to same may have various advantages, including but not limited to, enhanced bonding with the mat portion. The described lead alloy may also improve rigidity and strength of the border, which may improve handling and pasting, and overcome negative effects such as bending or curling of the lugs. The lead alloy may improve density, conductivity and tensile strength. The lead alloy may increase the hardness and strength of the strap, while imparting good melting, casting, and wetting properties. The lead alloy may also assist in reduce water consumption over the life of the battery, reduce electrolyte evolution and generation of hydrogen gas, have better self-discharge characteristics, and a consistent current draw. The foregoing advantages lead to improved performance, including charge acceptance, among other performance characteristics in a lead-acid battery.

While specific examples are shown, one of skill in the art will recognize that these are examples only and variations thereon may be made without departing from the overall scope of the present invention.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

The technical effects and technical problems in the specification are exemplary and are not limiting. It should be noted that the embodiments described in the specification may have other technical effects and can solve other technical problems.

1. A lead-acid battery comprising:
a container with a cover, the container having one or more compartments;
one or more cell elements are provided in the one or more compartments, the one or more cell elements comprising a positive electrode and a negative electrode, the positive electrode having a positive substrate or current collector and a positive electrochemically active material in contact with the positive substrate or current collector, the negative electrode having a negative substrate or current collector and a negative electrochemically active material in contact with the negative substrate or current collector;
wherein at least one of the positive electrode or the negative electrode comprises a cured carbon or carbonized fiber mat current collector impregnated with said respective electrochemically active material, the cured carbon or carbonized fiber mat current collector comprising a frame member composed of a lead-calcium alloy;
electrolyte provided within the container;
one or more terminal posts extending from the container or the cover and electrically coupled to the one or more cell elements.

2. The lead-acid battery of claim 1, wherein the frame member is a lead-calcium-tin alloy.

3. The lead-acid battery of claim 1, wherein the frame member comprises a strap bonded to the cured carbon or carbonized fiber mat.

4. The lead-acid battery of claim 3, wherein the frame member comprises a lug.

5. The lead-acid battery of claim 1, wherein at least one of the positive electrode or the negative electrode is a grid composed of a lead material.

6. The lead-acid battery of claim 1, wherein the one or more cell elements further comprise a separator.

7. The lead-acid battery of claim 6, wherein the separator is an absorbent glass mat.

8. The lead-acid battery of claim 1, wherein the positive electrochemically active material or the negative electrochemically active material further comprises an additive.

9. An electrode for a lead acid battery comprising:
a cured carbon or carbonized fiber mat current collector impregnated with an electrochemically active material, and a frame member composed of a lead-calcium alloy.

10. The electrode of claim 9, wherein the frame member comprises a strap bonded to the cured carbon or carbonized fiber mat.

11. The electrode of claim 10, wherein the frame member comprises a lug.

12. The electrode of claim 9, wherein the electrode is a negative electrode.

13. The electrode of claim 9, wherein the electrode is a positive electrode.

14. The electrode of claim 9, wherein the frame member is a lead-calcium-tin alloy.

15. A battery comprising the electrode of claim 9.

16. A current collector comprising:
a cured carbon or carbonized fiber mat, the cured carbon or carbonized fiber mat current collector comprising a frame member composed of a lead-calcium alloy.

17. The current collector of claim 16, wherein the frame member comprises a strap bonded to the cured carbon or carbonized fiber mat.

18. The current collector of claim 17, wherein the frame member comprises a lug.

19. The current collector of claim 16, wherein the frame member is a lead-calcium-tin alloy.

20. A battery having the current collector of claim 16.
